(19) United States
(12) Patent Application Publication
(10) Pub. No.: US 2014/0070949 A1
(43) Pub. Date: Mar. 13, 2014

(54) MUSCLE ACTIVITY TRAINING FACILITY FOR LOWER BODY OF USER

(71) Applicant: Paul CHEN, Vancouver (CA)

(72) Inventor: Paul CHEN, Vancouver (CA)

(21) Appl. No.: 13/609,463

(22) Filed: Sep. 11, 2012

(51) Int. Cl. G08B 23/00

(52) U.S. Cl. 340/573.1

(57) ABSTRACT

A muscle activity training facility includes a monitor electrically connecting to a processing device and having a screen, the screen includes two areas, and two figures in one of the areas for indicating the standard operations of the muscle groups in front and rear portions of the user, and two further figures in the other area for indicating the muscle groups in the front and the rear portions of the user, a carrier is attached to a lower body of the user, and a number of electrodes are attached to the carrier and electrically coupled to the processing device for detecting the activities of the muscle groups and for showing the detected activities of the muscle groups of the user in the other figures in the other area of the screen.

### BACKGROUND OF THE INVENTION

1. Field of the Invention

The present invention relates to a muscle activity training facility, and more particularly to a muscle activity training facility including a structure for easily and quickly and readily attaching or mounting or securing or wearing onto the lower body of the user and for contacting or engaging with the selected or predetermined or required portions of the muscle groups of the user and for suitably sensing or detecting or training the muscle exercises or operations or activities or the degrees of the muscle groups in the lower body of the user.

2. Description of the Prior Art

Typical muscle activity detecting or training facilities comprise one or more sensors or detectors or electrodes or transducers or electrical contacts or the like for attaching or mounting or securing onto various portions or positions or locations of a user and for sensing or detecting the muscle activities or operations or the degrees of the fatigue and pain of muscles or the like.

For example, U.S. Pat. No. 4,667,513 to Konno discloses one of the typical methods and apparatuses for estimating the degrees of the fatigue and pain of muscles and comparing subjects of different weights on the same basis by deriving the variation in the muscular strength such as the dorsal muscular strength, shoulder muscular strength, the grasping power, and the like as an electric signal and integrating the muscular output.

However, normally, the sensors or detectors or electrodes or transducers or electrical contacts or the like are attached or mounted or secured onto the user with tapes or adhesive materials and may not be solidly and stably attached or mounted or secured onto the user at the selected or required portions or positions or locations, particularly the hairy portions of the user, and may have a good chance to be disengaged from the user after use particularly when or while the muscles are moved or activated or operated.

U.S. Pat. No. 5,181,519 to Bible discloses another typical apparatus and method for detecting or monitoring heart muscle electrical activity including a plurality of electrical contacts and a monitoring unit, the contacts receive the electrical signals generated by the heart muscle of a patient and transmit the signals to the monitoring unit.

However, the electrical contacts are normally attached or mounted or secured onto the user with tapes or adhesive materials and may not be solidly and stably attached or mounted or secured onto the user at the selected or required portions or positions or locations, particularly the hairy portions of the user, and also may have a good chance to be disengaged from the user after use particularly when or while the muscles are moved or activated or operated.

U.S. Pat. No. 6,496,739 to Arbel discloses a further typical apparatus and method including a set or a number of electrode positioners for skin-contacting surface electrodes used for electrical muscular stimulation in conjunction with a splint, the set including at least one electrode positioner in the form of a scoop-like structure.

However, the splint may not be easily attached or mounted or secured onto the selected or required portions or positions or locations of the user, such as the trunk or body portion of the user and thus may not be used to suitably sense or detect the muscle activities of the user.

U.S. Pat. No. 7,593,768 to Vasiliev et al. discloses a still further typical system and method for determining smooth muscle motor activity in body organs, the system comprises electrodes for recording an analog signal in the subject's body, an analog to digital converter that converts the analog signal to a digital signal and a processor.

However, the electrodes are normally attached or mounted or secured onto the user with tapes or adhesive materials or the like and may not be solidly and stably attached or mounted or secured onto the user at the selected or required portions or positions or locations, particularly the hairy portions of the user, and also may have a good chance to be disengaged from the user after use particularly when or while the muscles are moved or activated or operated.

Actually, the sensors or detectors or electrodes or transducers or electrical contacts or the like of the typical muscle activity detecting or training facilities may not be easily and quickly and readily attached or mounted or secured onto the lower body of the user and may not be used to correctly or properly sense or detect or train the muscle groups in the lower body of the user, and the positions or locations of the sensors or detectors or electrodes or transducers or electrical contacts or the like should be attached or mounted or secured onto the user by trial and error method and should be calibrated many times.

The present invention has arisen to mitigate and/or obviate the afore-described disadvantages of the conventional muscle activity detecting or training facilities.

### SUMMARY OF THE INVENTION

The primary objective of the present invention is to provide a muscle activity training facility including a structure for easily and quickly and readily attaching or mounting or securing or wearing onto the lower body of the user and for contacting or engaging with the selected or predetermined or required portions of the muscle groups of the user and for suitably sensing or detecting or training the muscle exercises or operations or activities or the degrees of the muscle groups in the lower body of the user.

In accordance with one aspect of the invention, there is provided a muscle activity training facility comprising a processing device, a monitor electrically connecting to the processing device, the monitor including a screen provided thereon, and the screen including a first area and a second area, and including two first figures formed or provided in the first area for indicating the standard or predetermined or tested and processed operations of the muscle groups in front and rear portions of a user respectively, and including two second figures provided in the second area for indicating the exercising operations of muscle groups in the front and the rear portions of the user respectively, a carrier for attaching to a lower body of the user, and a number of electrodes attached to the carrier at selected locations of the carrier corresponding to the predetermined portions or positions of the muscle groups of the user, and electrically coupling to the processing device for detecting operations and activities of the muscle groups of the user and for sending detected signals to the processing device and for showing and indicating and displaying the detected operations and activities of the muscle groups of the user in the second figures in the second area of the screen and for allowing the user to compare the difference between the first figures and the second figures and to change the operations and/or the activities of the muscle groups of the user.

The carrier includes a chamber formed therein for receiving and engaging with the lower body of the user, and includes two lower openings formed therein and communicating with the chamber thereof for receiving and engaging with upper legs of the user and for allowing the carrier to be worn onto the lower body of the user.

The carrier includes a G-sensor attached thereto for further sensing or detecting the operations and/or the activities of the muscle groups of the user. The monitor includes a selected area of the screen for showing and indicating and displaying the operations and activities of the muscle groups of the user. The carrier includes at least one pointer provided thereon for aligning with a reference portion of the user and for suitably aligning the electrodes with the predetermined or selected muscle groups of the user. The carrier is selected from a flexible detective pad or cloth member or the like for easily and readily attaching or wearing onto the user.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a muscle activity training facility in accordance with the present invention;

FIG. 2 is a plan schematic view of a display screen of the muscle activity training facility;

FIG. 3 is a lower perspective view illustrating a carrier of the muscle activity training facility;

FIG. 4 is a partial front plan schematic view of a front portion of a user, illustrating the attachment of the muscle activity training facility to the lower body of the user;

FIG. 5 is a partial rear plan schematic view of a rear portion of the user, illustrating the attachment of the muscle activity training facility to the lower body of the user;

FIG. 6 is another plan schematic view illustrating the display screen of the muscle activity training facility; and

FIGS. 7, 8, 9 are plan schematic views similar to FIGS. 2 and 6, illustrating the operation of the muscle activity training facility for the lower body of the user.

### DETAILED DESCRIPTION OF THE PREFERRED EMBODIMENT

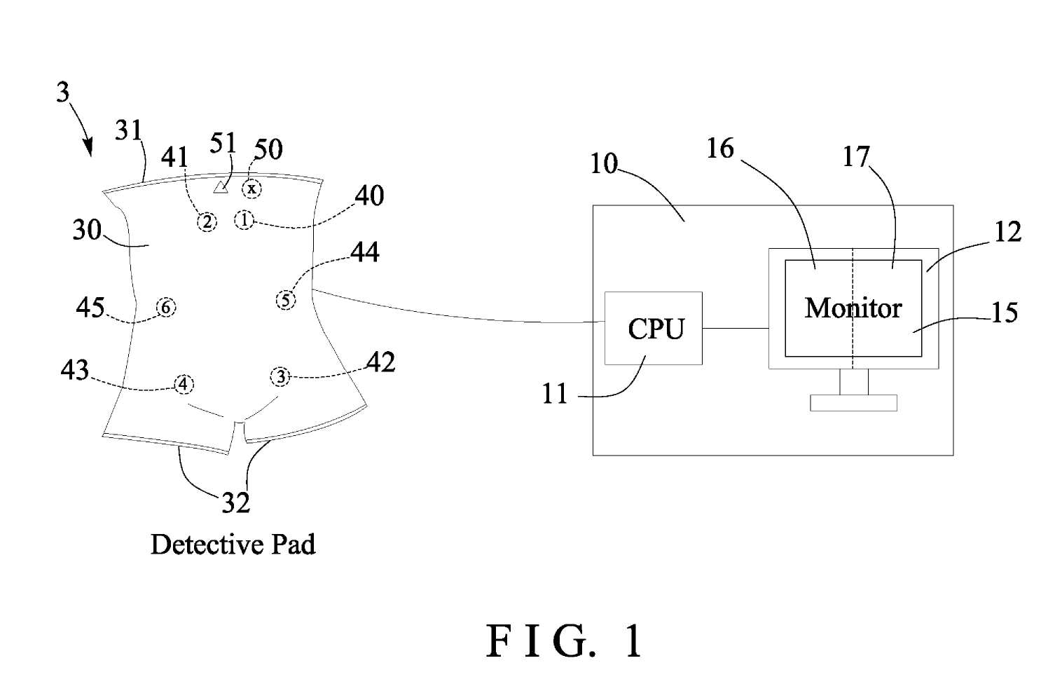

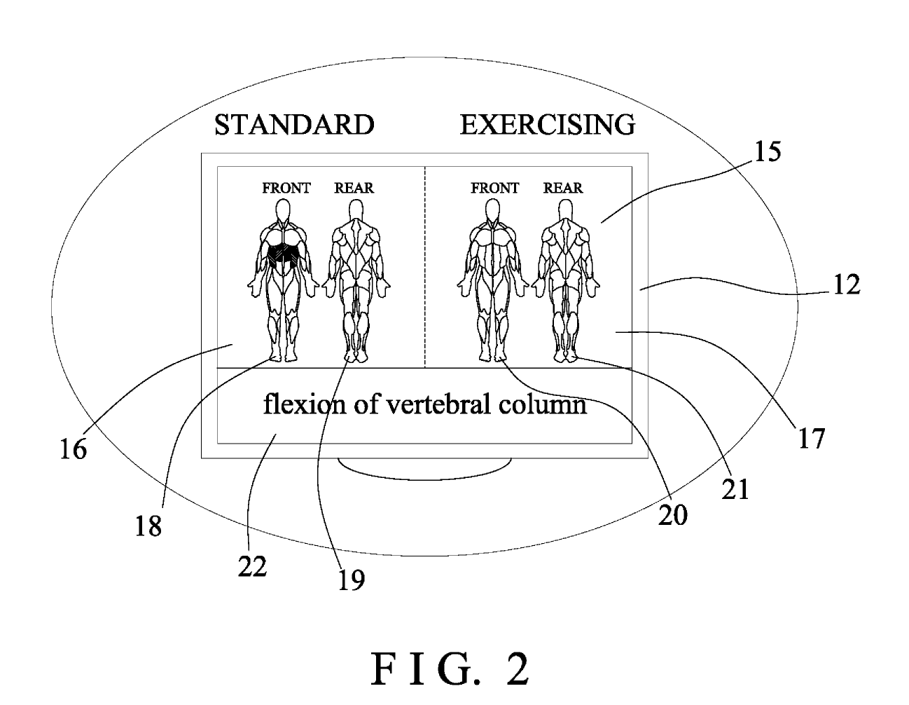

Referring to the drawings, and initially to FIG. 1, a muscle activity training facility in accordance with the present invention comprises a computer facility or device 10 including a processor or control device or central processing unit (CPU) or processing device 11, and a displayer device or monitor 12 electrically connected or coupled to the central processing unit (CPU) or processing device 11, in which the monitor 12 includes a screen 15 formed or provided thereon for displaying or showing various data or figures or information or the like. For example, as shown in FIGS. 2 and 6-9, the screen 15 of the monitor 12 may be used or provided for displaying or showing or indicating the front plan schematic view and the rear plan schematic view of the user 8 (FIGS. 4-5), and/or the status or actuations or operations or activities or movements or exercises of the user 8.

Referring to FIGS. 1 and 3-5, the muscle activity training facility further comprises an attaching or mounting or carrying or sensing or detective pad or adapting device 3 including a spatial and flexible or three-dimensional member or carrier 30 made of nonwoven or woven paper or composite or plastic or rubber pad or cloth materials or the like for attaching or mounting or securing or wrapping or winding or wearing or engaging onto the lower body 80 of the user 8 (FIGS. 4-5) and for firmly or solidly and stably anchoring or retaining or securing onto the lower body 80 of the user 8 and for preventing the adapting device 3 from being disengaged or separated from the lower body 80 of the user 8 even when the lower body 80 of the user 8 is conducting serious or intense or agitated exercise operations.

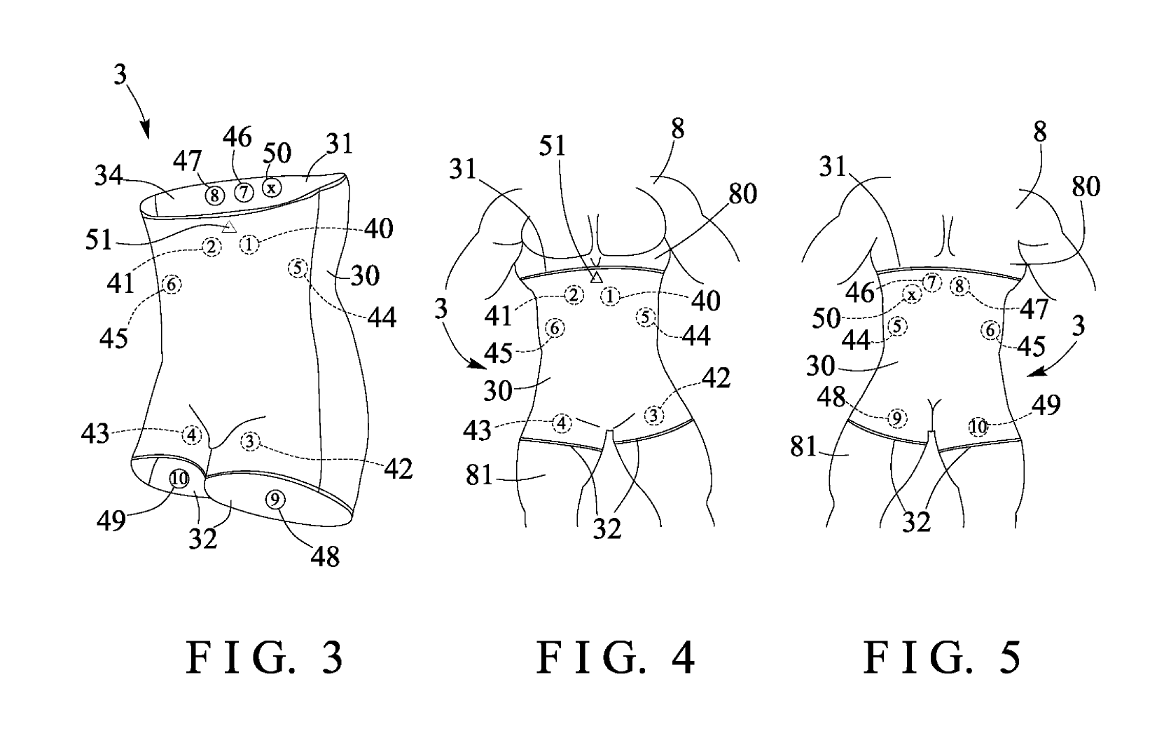

For example, the spatial and flexible or three-dimensional member or detective pad or carrier 30 of the adapting device 3 includes a chamber 31 formed therein (FIG. 3) for receiving or engaging with the waist portion or lower body 80 of the user 8, and includes two lower openings 32 formed therein and communicating with the chamber 31 thereof for receiving or extending or engaging with the pelvic girdle and/or the upper legs 81 of the user 8, and thus for allowing the spatial and flexible or three-dimensional member or carrier 30 of the adapting device 3 to be firmly or solidly and stably attached or mounted or anchored or retained or secured onto the lower body 80 of the user 8, and thus for preventing the carrier 30 of the adapting device 3 from being disengaged or separated from the user 8 even when the user 8 is conducting serious or intense or agitated exercise operations.

As also shown in FIGS. 1 and 3-5, a number of transducers or electrical contacts or sensors or detectors or electrodes 40-49 or the like are further provided and attached or mounted or secured onto the carrier 30, particularly the interior or inner peripheral portion 34 of the carrier 30 (FIG. 3) at various or selected or predetermined portions or positions or locations of the carrier 30, for example, the electrodes 40, 41, 42, 43 are disposed or located at the front portion of the carrier 30 and to be attached or mounted or secured or contacted or engaged onto the waist or abdominal portion and the upper legs of the lower body 80 of the user 8 respectively, the electrodes 44, 45 are arranged to be attached or mounted or secured or contacted or engaged onto the side positions of the lower body 80 of the user 8, and the other electrodes 46-49 are disposed or located at the other positions or locations corresponding to the other positions or back portion of the lower body 80 of the user 8, such as the middle and back portion and the upper legs of the lower body 80.

As also shown in FIGS. 1, 3 and 5, a further transducer or electrical contact or sensor or detector or electrode 50, such as a G-sensor 50 or the like may further be provided and attached or mounted or secured onto the interior or inner peripheral portion 34 of the carrier 30 at the other selected or predetermined portions or positions or locations of the carrier 30, for example, the electrode 50 is disposed or located at the upper and rear or back portion of the carrier 30 corresponding to the back portion of the user 8 for sensing or detecting the activities or exercise operations of the back portion of the user 8, such that the electrodes 40-50 may be used or provided for sensing or detecting the muscle or joint or link activities or the exercise operations of the muscle or the joints or the links or the like of the user 8.

The electrodes 40-50 are also electrically connected or coupled to the central processing unit (CPU) or processing device 11 for sending or transmitting the sensed or detected signals to the CPU or processing device 11. The adapting device 3 further includes one or more indicators or pointers 51 formed or provided thereon (FIGS. 1 and 3-4) for indicating or aligning with various selected or predetermined or reference portions or positions or locations of the user 8, such as the manubrium, the sternum, or the xiphoid process of the user 8 (FIG. 4), etc. for allowing the electrodes 40-50 to be suitably attached or mounted or secured or contacted or engaged with the selected or predetermined or required portions or positions or locations of the muscle or the joints or the links or the like of the user 8.

As shown in FIGS. 2 and 6-9, the screen 15 of the monitor 12 includes two halves or portions or areas 16, 17, for example, the left or first half or portion or area 16 of the screen 15 of the monitor 12 includes two FIGS. 18, 19 that may be used or provided for displaying or showing the muscle groups in the front and the rear portions of the user 8 respectively, particularly, the FIGS. 18, 19 at the left or first half or portion or area 16 of the screen 15 of the monitor 12 are provided for displaying or showing the standard or predetermined or tested or correct activities or operations of the muscle groups of the user 8 that have been predetermined and recorded or stored in the computer facility or device 10 and that may be indicated or displayed or shown by shaded lines, different colors, the darkness, the brightness or the like.

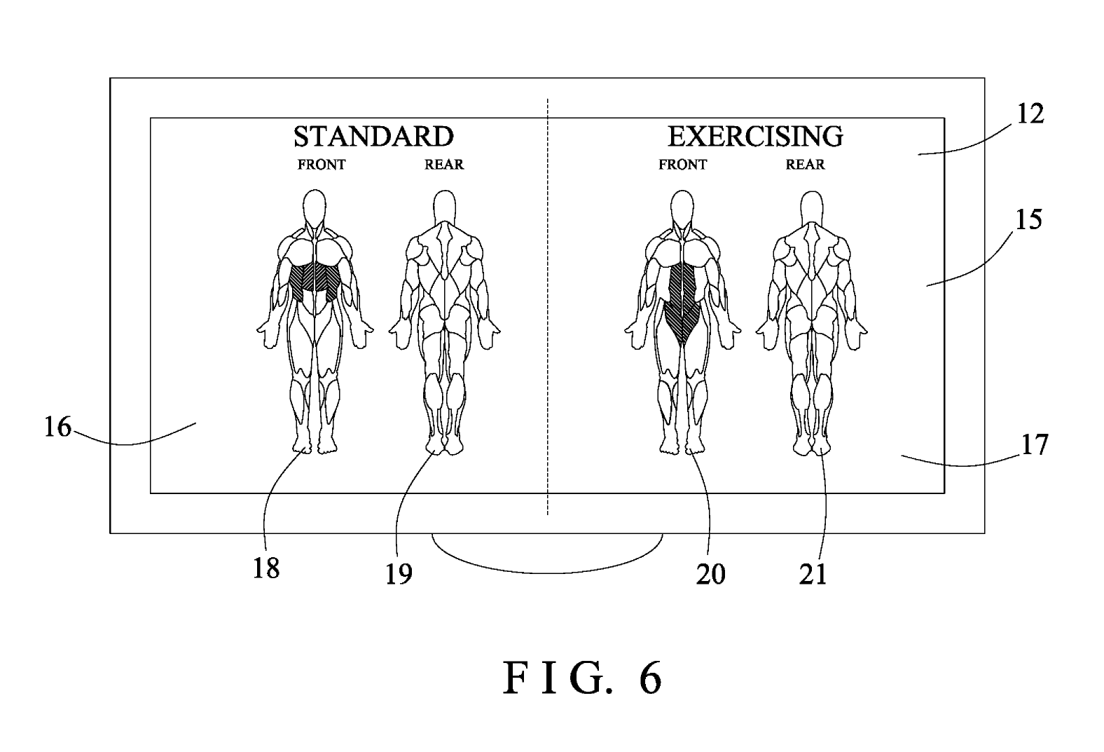

The right or second half or portion or area 17 of the screen 15 of the monitor 12 also includes two FIGS. 20, 21 (FIGS. 2 and 6) that may also be used or provided for displaying or showing the muscle groups in the front and the rear portions of the user 8 respectively; particularly, the FIGS. 20, 21 at the right or second half or portion or area 17 of the screen 15 of the monitor 12 are provided for displaying or indicating or showing the signals detected and transmitted from the electrodes 40-50 and/or processed or treated by the central processing unit (CPU) or processing device 11 of the computer facility or device 10, in which the FIGS. 20, 21 may also be indicated or displayed or shown by shaded lines, different colors, the darkness, the brightness or the like for indicating the status or actuations or operations or activities or movements or exercises of the muscle groups in the lower body 80 of the user 8.

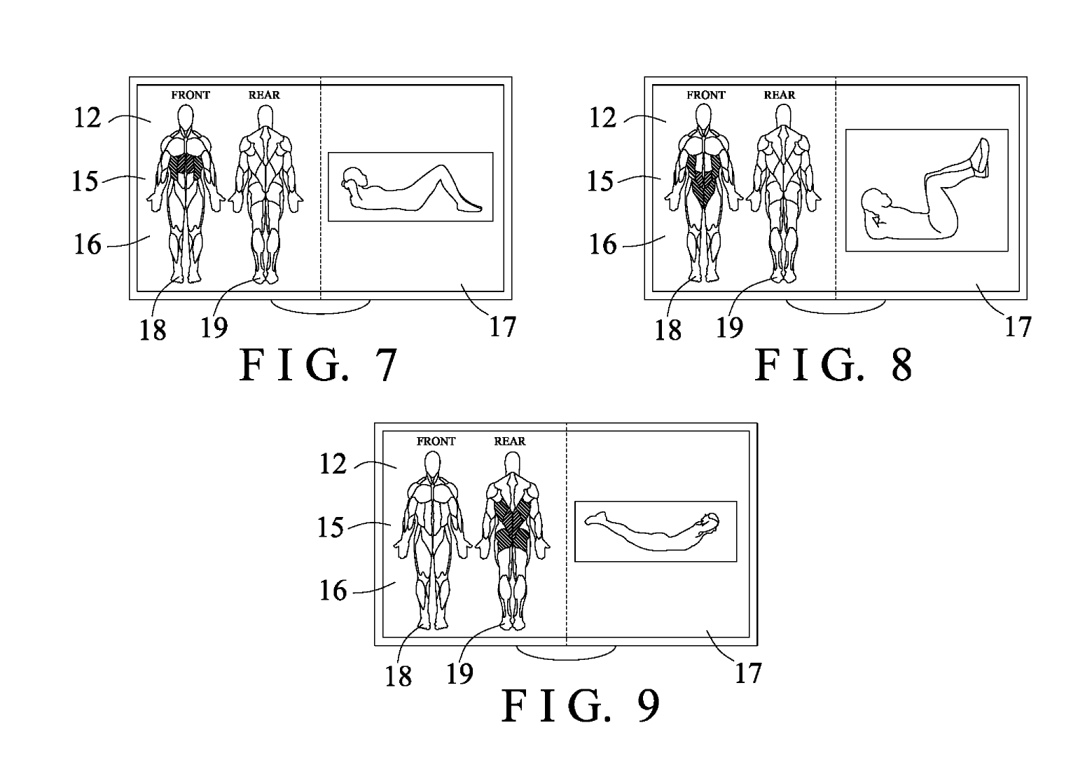

Alternatively, or in replacement, as shown in FIGS. 7-9, instead of the FIGS. 20, 21, the right or second half or portion or area 17 of the screen 15 of the monitor 12 may also be used or provided for displaying or showing the actuating or operating or acting or moving or exercising of the user 8. For example, as shown in FIG. 7, when the lower body 80 of the user 8 is actuated or operated or acted or moved or exercised, such as the flexion of the vertebral column (FIG. 7, the right area 17 of the screen 15), the flexion of thigh or knee bends (FIG. 8, the right area 17 of the screen 15), the extension of the vertebral column and the extension of the thigh of the user 8 (FIG. 9, the right area 17 of the screen 15), or the like.

It is to be noted that the muscle groups as shown in the left area 16 of the screen 15 may show or indicate that the selected muscle groups of the user 8 are properly or suitably and correctly used or operated, and the data or information of the selected muscle groups of the user 8 have been previously sensed or detected or tested or predetermined and recorded or stored in the computer facility or device 10 as the standard or correct activities or operations of the muscle groups of the user 8. The actuations or operations or activities or movements or exercises of the other muscle groups of the user 8 that have not been shown or indicated in FIGS. 7-9 may also be tested or predetermined and recorded or stored in the computer facility or device 10.

In operation, as shown in FIGS. 4-5, the carrier 30 of the adapting device 3 may be attached or mounted or secured or engaged onto the selected or predetermined or reference portions or positions or locations of the lower body 80 of the user 8 by aligning the pointers 51 of the carrier 30 with the selected or predetermined or reference portions or positions or locations of the user 8 as previously described. As shown in FIG. 2, the user may then select or choose the required or predetermined actuation or operation or activity or movement or exercise to be conducted, such as the flexion of the vertebral column, which will be shown or indicated or displayed in the lower or selected area 22 of the screen 15 of the monitor 12, and/or will be shown or indicated or displayed in the right or second half or portion or area 17 of the screen 15 of the monitor 12 (FIGS. 7-9).

When or while the user 8 is conducting the selected or predetermined or required activity or movement or exercise operation or actuation, as shown in FIGS. 2 and 6, the FIGS. 20, 21 may then be shown and displayed on the right or second half or portion or area 17 of the screen 15 of the monitor 12 and may be indicated or displayed or shown by shaded lines, different colors, the darkness, the brightness or the like for indicating the status or actuations or operations or activities or movements or exercises of the muscle groups in the lower body 80 of the user 8. The user 8 may then compare the FIGS. 20, 21 at the right or second area 17 of the screen 15 with the FIGS. 18, 19 at the left or first area 16 of the screen 15, and may then determine the difference between the muscle groups in the FIGS. 18, 19, 20, 21, in order to correct the activity or exercise operation of the user 8.

It is to be noted that the carriers 30 of the adapting device 3 may be easily and quickly and readily and solidly and stably attached or mounted or secured or engaged onto the selected or predetermined or reference portions or positions or locations or the lower body 80 of the user 8 by aligning the pointers 51 of the carriers 30 with the selected or predetermined or reference portions or positions or locations of the user 8, and the electrodes 40-50 may be suitably attached or mounted or secured or contacted or engaged with the selected or predetermined or required portions or positions or locations of the muscle groups or the joints or the links or the like of the user 8 for properly or suitably and correctly using or operating or sensing or detecting or training the muscle groups in the lower body of the user.

Accordingly, the muscle activity training facility in accordance with the present invention includes a structure for easily and quickly and readily attaching or mounting or securing or wearing onto the lower body of the user and for attaching the electrodes onto the user to contact or engage with the selected or predetermined or required portions of the muscle groups of the user and for suitably or properly sensing or detecting or training the muscle exercises or operations or activities or the degrees of the muscle groups in the lower body of the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A muscle activity training facility comprising:
a processing device,
a monitor electrically connecting to said processing device, said monitor including a screen provided thereon, and said screen including a first area and a second area, and including two first figures in said first area for indicating standard operations of muscle groups in front and rear portions of a user respectively, and including two second figures in said second area for indicating operations of muscle groups in the front and the rear portions of the user respectively,
a carrier for attaching to a lower body of the user, and
a plurality of electrodes attached to said carrier at selected locations of said carrier corresponding to predetermined positions of the muscle groups of the user, and electrically coupling to said processing device for detecting operations and activities of the muscle groups of the user and for sending detected signals to said processing device and for showing and indicating and displaying the detected operations and activities of the muscle groups of the user in said second figures in said second area of said screen.

2. The muscle activity training facility as claimed in claim 1, wherein said carrier includes a chamber formed therein for receiving and engaging with the lower body of the user, and includes two lower openings formed therein and communicating with said chamber thereof for receiving and engaging with upper legs of the user and for wearing onto the lower body of the user.

3. The muscle activity training facility as claimed in claim 1, wherein said carrier includes a G-sensor attached thereto.

4. The muscle activity training facility as claimed in claim 1, wherein said monitor includes a selected area of said screen for showing and indicating and displaying the operations and activities of the muscle groups of the user.

5. The muscle activity training facility as claimed in claim 1, wherein said carrier includes at least one pointer provided thereon for aligning with a reference portion of the user.

6. The muscle activity training facility as claimed in claim 1, wherein said carrier is selected from a flexible cloth member.
